(19) United States
(12) Patent Application Publication
(10) Pub. No.: US 2020/0135415 A1
(43) Pub. Date: Apr. 30, 2020

(54) SWITCH MODULE AND MOUSE DEVICE WITH SAME

(71) Applicant: Primax Electronics Ltd., Taipei (TW)

(72) Inventors: Chia-Yuan Chang, Taipei (TW); Chun-Lin Chu, Taipei (TW); Chih-Hung Hsieh, Taipei (TW)

(21) Appl. No.: 16/232,903

(22) Filed: Dec. 26, 2018

(30) Foreign Application Priority Data
Oct. 26, 2018 (TW) 107138034

(51) Int. Cl. H01H 13/04; H01H 13/52; H01H 13/12; G06F 3/0354; G06F 3/0362

(52) U.S. Cl. CPC H01H 13/04; H01H 13/52; H01H 13/10; G06F 3/03543; G06F 3/0362; H01H 13/12

(57) ABSTRACT

A switch module includes a switch base, a common terminal, a normally open terminal, a resilient piece, an upper cover and a soft element. The resilient piece includes a first portion and a second portion. The first portion of the resilient piece is disposed on the common terminal. The second portion of the resilient piece is located over the normally open terminal. The upper cover is disposed on the switch base to cover the common terminal, the normally open terminal and the resilient piece. The soft element is arranged between the upper cover and the second portion of the resilient piece. When an external force exerted on the resilient piece is eliminated, the second portion of the resilient piece is moved in a direction away from the switch base in response to an elastic restoring force of the resilient piece.

### FIELD OF THE INVENTION

The present invention relates to a mouse device, and more particularly to a mouse device with reduced click sound.

### BACKGROUND OF THE INVENTION

In the digitalized era, computers and associated electronic devices are very popular. For example, computers become essential devices in every family. As known, a mouse device is an important input device for the computer system. Via the mouse device, the user may communicate with the computer system. In addition, the mouse devices with improved or new functions are gradually developed.

The structure of a conventional mouse device will be described as follows. FIG. 1 is a schematic cutaway view illustrating the structure of a conventional mouse device. As shown in FIG. 1, the mouse device 1 comprises a mouse base 10, a mouse case 11, two buttons 12, a scroll wheel 14, a circuit board 15 and two micro switches 16. The circuit board 15 is disposed on the mouse base 10. The micro switches 16 are installed on the circuit board 15. The mouse case 11 is also disposed on the mouse base 10 for covering the mouse base 10. The buttons 12 are disposed on the mouse case 11 and located over the corresponding micro switches 16. Each button 12 has a triggering part 13. By rotating the scroll wheel 14, a window scrolling function is executed.

By clicking one of the buttons 12, the button 12 is moved downwardly and the triggering part 13 of the button 12 is moved downwardly to trigger the corresponding micro switch 16. Consequently, the micro switch 16 issues a signal to the circuit board 15. According to the control signal, the circuit board 15 executes a corresponding button function.

Hereinafter, the inner structure of the micro switch will be illustrated as follows with reference to FIG. 2A and FIG. 2B. FIG. 2A is a schematic perspective view illustrating a micro switch of the conventional mouse device. FIG. 2B is a schematic cutaway view illustrating the micro switch of the conventional mouse device. The micro switch 16 comprises a switch base 161, a pressing element 168 and an upper cover 162. A perforation 163 is formed in the upper cover 162. The micro switch 16 further comprises a common terminal 165, a normally open terminal 166, a normally close terminal 164 and a resilient piece 167. The common terminal 165 is disposed on an end of the base 161. The normally open terminal 166 is disposed on another end of the base 161. The normally close terminal 164 is located beside the normally open terminal 166. A first end of the resilient piece 167 is disposed on the common terminal 165. A salient 1671 is formed on a second end of the resilient piece 167. In case that the pressing element 168 is contacted with the resilient piece 167 and no external force is exerted on the pressing element 168, the salient 1671 is contacted with the normally close terminal 164. Moreover, the pressing element 168 comprises a pressing part 1681 and a protrusion edge 1682. The pressing part 1681 of the pressing element 169 is penetrated through the perforation 163 of the upper cover 162, and the protrusion edge 1681 near the pressing part 1681 is in contact with the periphery of the perforation 163 of the upper cover 162. Consequently, the pressing element 168 is not escaped out of the perforation 163.

The micro switch 16 is enabled to generate a switching signal according to the contact relationship between the resilient piece 167 and the common terminal 165, the normally open terminal 166 and the normally close terminal 164. In a case that no external force is exerted on the pressing element 168, the salient 1671 at the second end of the resilient piece 167 is contacted with the normally close terminal 164. In case that the pressing element 168 is pressed by the triggering part 13 (as shown in FIG. 1), the pressing element 168 is moved downwardly to push the resilient piece 167. Consequently, the salient 1671 of the resilient piece 167 is separated from the normally close terminal 164 and then contacted with the normally open terminal 166. Meanwhile, a loop is defined by the common terminal 165, the resilient piece 167 and the normally open terminal 166 collectively, and the micro switch 16 generates an enabling signal. When the external force exerted on the pressing element 168 is eliminated, the resilient piece 167 is no longer pressed by the pressing element 168. Consequently, the resilient piece 167 is separated from the normally open terminal 166, and the salient 1671 is in contact with the normally close terminal 164 again.

As mentioned above, when the pressing element 168 is pressed down, the pressing element 168 is moved downwardly to push the resilient piece 167. Consequently, the resilient piece 167 is contacted with the normally open terminal 166 to form the loop, and the enabling signal is generated. When the external force exerted on the pressing element 168 is eliminated, the pressing element 168 is returned to its original position in response to the elastic force of the resilient piece 167. While the resilient piece 167 is returned to its original position, the salient 1671 of the resilient piece 167 often collides with the normally close terminal 164. Since the salient 1671 and the normally close terminal 164 collide with each other during the operation of the micro switch 16, a loud clicking noise is readily generated.

Therefore, there is a need of providing an improved switch module in order to overcome the drawbacks of the conventional technologies.

### SUMMARY OF THE INVENTION

A first object of the present invention provides a switch module. The switch module is equipped with a soft element between an upper cover and a resilient piece. While the resilient piece is returned back, the resilient piece is contacted with the soft element. Since the resilient piece does not directly collide with the upper cover to generate the sound, the noise generated by the switch module is reduced.

A second object of the present invention provides a mouse device with a switch module. The switch module is equipped with a soft element between an upper cover and a resilient piece. While the resilient piece is returned back, the resilient piece is contacted with the soft element. Since the resilient piece does not directly collide with the upper cover to generate the sound, the noise generated by the switch module is reduced.

The other objects and advantages of the present invention will be understood from the disclosed technical features.

In accordance with an aspect of the present invention, there is provided a switch module. The switch module includes a switch base, a common terminal, a normally open terminal, a resilient piece, an upper cover and a soft element. The common terminal is disposed on a first end of the switch base. The normally open terminal is disposed on a second end of the switch base. The first end and the second end are opposed to each other. The resilient piece includes a first portion and a second portion. The first portion of the resilient piece is disposed on the common terminal. The second portion of the resilient piece is located over the normally open terminal. The upper cover is disposed on the switch base. The common terminal, the normally open terminal and the resilient piece are covered by the upper cover. The soft element is arranged between the upper cover and the second portion of the resilient piece. When an external force is exerted on the resilient piece to press the resilient piece, the resilient piece is subjected to deformation and the second portion of the resilient piece is moved toward the switch base and contacted with the normally open terminal, so that electric connection between the common terminal and the normally open terminal is established. When the external force exerted on the resilient piece is eliminated, the second portion of the resilient piece is moved in a direction away from the switch base in response to an elastic restoring force of the resilient piece, so that the second portion of the resilient piece is contacted with the soft element.

In accordance with another aspect of the present invention, there is provided a mouse device. The mouse device includes a mouse base, a mouse case, a button, a circuit board and a switch module. The mouse base is covered by the mouse case. The button is installed on the mouse case. An operation surface of the button is exposed outside an outer surface of the mouse case, so that the button is operable. The circuit board is disposed on the mouse base. The switch module is arranged between the circuit board and the button. The switch module includes a switch base, a common terminal, a normally open terminal, a resilient piece, an upper cover and a soft element. The common terminal is disposed on a first end of the switch base. The normally open terminal is disposed on a second end of the switch base. The first end and the second end are opposed to each other. The resilient piece includes a first portion and a second portion. The first portion of the resilient piece is disposed on the common terminal. The second portion of the resilient piece is located over the normally open terminal. The upper cover is disposed on the switch base. The common terminal, the normally open terminal and the resilient piece are covered by the upper cover. The soft element is arranged between the upper cover and the second portion of the resilient piece. When an external force is exerted on the resilient piece to press the resilient piece, the resilient piece is subjected to deformation and the second portion of the resilient piece is moved toward the switch base and contacted with the normally open terminal, so that electric connection between the common terminal and the normally open terminal is established. When the external force exerted on the resilient piece is eliminated, the second portion of the resilient piece is moved in a direction away from the switch base in response to an elastic restoring force of the resilient piece, so that the second portion of the resilient piece is contacted with the soft element.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cutaway view illustrating the structure of a conventional mouse device;

FIG. 2A is a schematic perspective view illustrating a micro switch of the conventional mouse device;

FIG. 2B is a schematic cutaway view illustrating the micro switch of the conventional mouse device;

FIG. 3 is a schematic cutaway view illustrating the structure of a mouse device according to an embodiment of the present invention;

FIG. 4 is a schematic cross-sectional view illustrating the switch module as shown in FIG. 3;

FIG. 5A is a schematic cross-sectional view illustrating the switch module as shown in FIG. 4, in which the switch module is pressed down; and

FIG. 5B is a schematic cross-sectional view illustrating the switch module as shown in FIG. 4, in which the external force exerted on the switch module is eliminated.

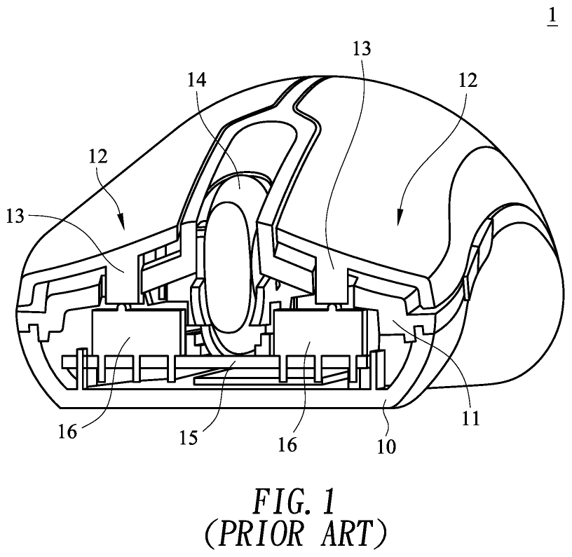

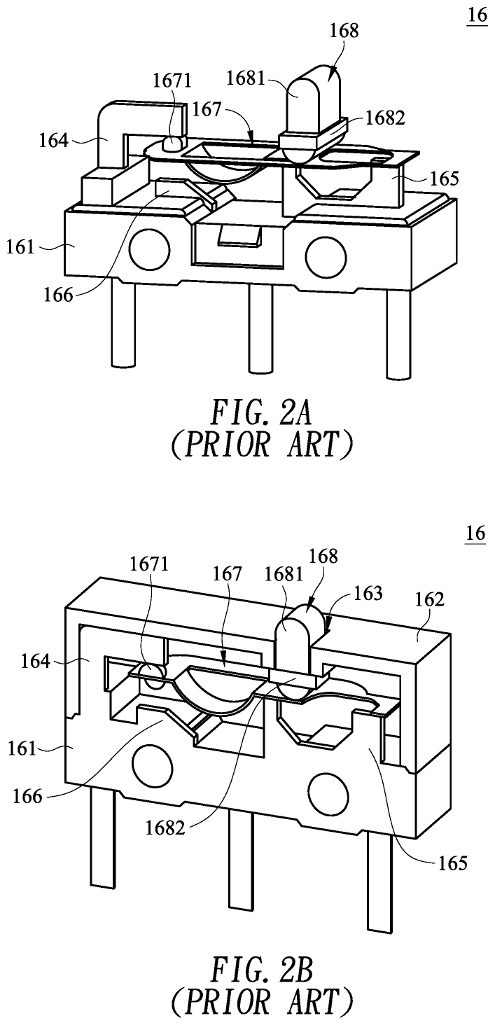

### DETAILED DESCRIPTION OF THE PREFERRED EMBODIMENT

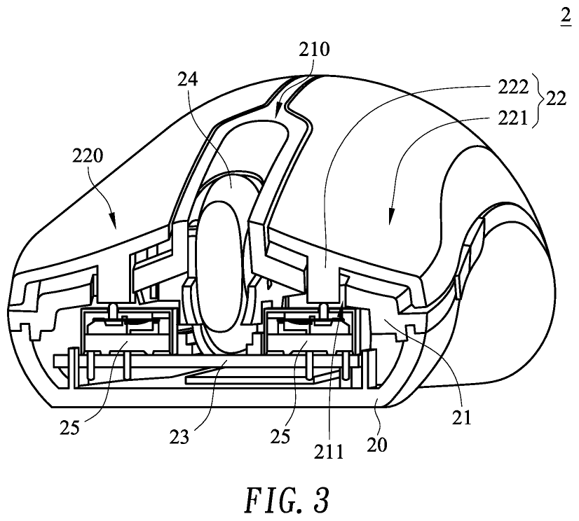

FIG. 3 is a schematic cutaway view illustrating the structure of a mouse device according to an embodiment of the present invention. As shown in FIG. 3, the mouse device 2 comprises a mouse base 20, a mouse case 21, two buttons 22, a circuit board 23, a scroll wheel 24 and two switch modules 25. The mouse case 21 is disposed on the mouse base 20 for covering the mouse base 20. The buttons 22 are disposed on the mouse case 21. Moreover, the operation surfaces 220 of the buttons 22 are exposed outside an outer surface 210 of the mouse case 21. Consequently, the buttons 22 can be pressed and operated by the user. The circuit board 15 is disposed on the mouse base 20. The scroll wheel 24 is installed on the mouse case 21. A portion of the scroll wheel 24 is exposed outside the mouse case 21 so as to be operated by the user. By rotating the scroll wheel 24, a window scrolling function is executed. The switch module 25 is arranged between the circuit board 23 and the corresponding button 22. The mouse case 21 has an opening 211. Each button 22 comprises a button body 221 and a triggering part 222. The button body 221 has the operation surface 220. The triggering part 222 is protruded in the direction toward the mouse base 20. Moreover, the triggering part 222 is penetrated through the opening 211 of the mouse case 21 and contacted with the corresponding switch module 25.

The structure of the switch module 25 will be described in more details as follows.

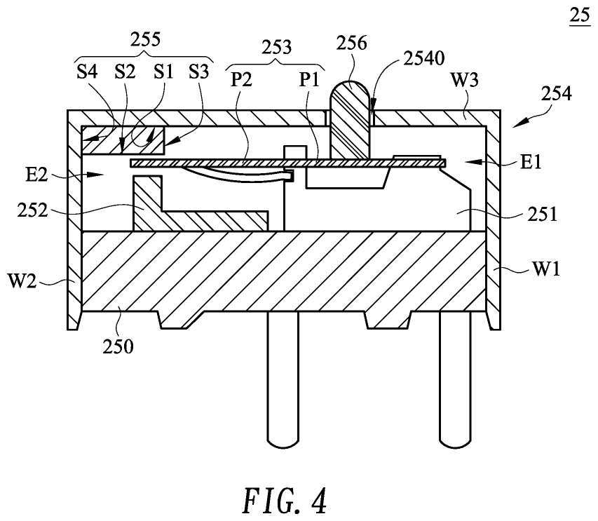

FIG. 4 is a schematic cross-sectional view illustrating the switch module as shown in FIG. 3. As shown in FIG. 4, the switch module 25 comprises a switch base 250, a common terminal 251, a normally open terminal 252, a resilient piece 253, an upper cover 254 and a soft element 255. The common terminal 251 is disposed on a first end E1 of the switch base 250. The normally open terminal 252 is disposed on a second end E2 of the switch base 250. The first end E1 and the second end E2 are opposed to each other. The resilient piece 253 comprises a first portion P1 and a second portion P2. The first portion P1 of the resilient piece 253 is disposed on the common terminal 251. The second portion P2 of the resilient piece 253 is located over the normally open terminal 252. The upper cover 254 is disposed on the switch base 250. The common terminal 251, the normally open terminal 252, the resilient piece 253 and the soft element 255 are covered by the upper cover 254. The soft element 255 is arranged between the upper cover 254 and the second portion P2 of the resilient piece 253.

Please refer to FIG. 4 again. The upper cover 254 comprises a first lateral wall W1, a second lateral wall W2 and a top wall W3. The first lateral wall W1 and the second lateral wall W2 are opposed to each other. The top wall W3 is connected between the first lateral wall W1 and the second lateral wall W2. The top wall W3 of the upper cover 254 and the switch base 250 are opposed to each other. That is, the common terminal 251, the normally open terminal 252, the resilient piece 253 and the soft element 255 are arranged between the top wall W3 and the switch base 250. The first lateral wall W1 of the upper cover 254 is located near the common terminal 251. The second lateral wall W2 of the upper cover 254 is located near the normally open terminal 252. The soft element 255 is arranged between the top wall W3 of the upper cover 254 and the second portion P2 of the resilient piece 253.

In this embodiment, the soft element 255 has a top surface S1, a bottom surface S2, a first lateral surface S3 and a second lateral surface S4. The top surface S1 and the bottom surface S2 are opposed to each other. The first lateral surface S3 and the second lateral surface S4 are connected between the top surface S1 and the bottom surface S2. The top surface S1 of the soft element 255 faces the top wall W3 of the upper cover 254. The bottom surface S2 of the soft element 255 faces the switch base 250. That is, the bottom surface S2 of the soft element 255 faces the second portion P2 of the resilient piece 253. The first lateral surface S3 of the soft element 255 faces the first lateral wall W1 of the upper cover 254. The second lateral surface S4 of the soft element 255 faces the second lateral wall W2 of the upper cover 254. In this embodiment, the top surface S1 of the soft element 255 is in contact with the top wall W3 of the upper cover 254, and the second lateral surface S4 of the soft element 255 is in contact with the second lateral wall W2 of the upper cover 254. The above connecting relationship between the soft element 255 and the upper cover 254 is presented herein for purpose of illustration and description only. It is noted that the connecting relationship between the soft element 255 and the upper cover 254 is not restricted. For example, in another embodiment, only the top surface S1 of the soft element 255 is in contact with the top wall W3 of the upper cover 254.

Please refer to FIG. 4 again. The switch module 25 further comprises a pressing element 256. Moreover, the upper cover 254 has a perforation 2540. The perforation 2540 runs through the top wall W3 of the upper cover 254. In this embodiment, the pressing element 256 is in contact with the first portion P1 of the resilient piece 253. The pressing element 256 is protruded in the direction away from the resilient piece 253 and penetrated through the perforation 2540 of the upper cover 254. While the button 22 is pressed down, the triggering part 222 (see FIG. 3) of the button 22 is moved downwardly to press the pressing element 256. Consequently, the first portion P1 of the resilient piece 253 is pushed by the pressing element 256, and the resilient piece 253 is subjected to deformation.

The operations of the switch module 25 will be described in more details as follows.

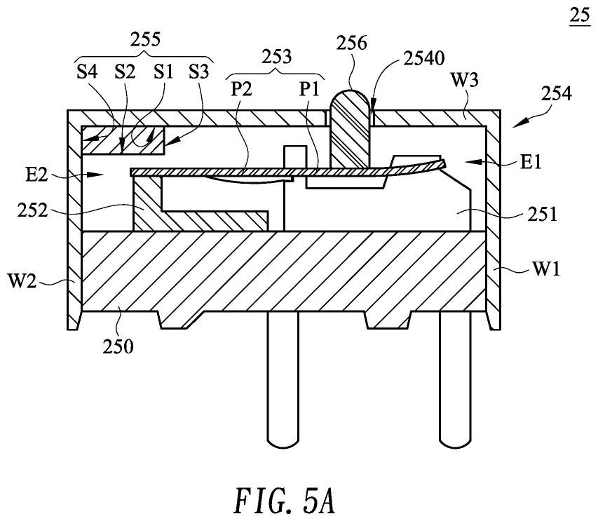

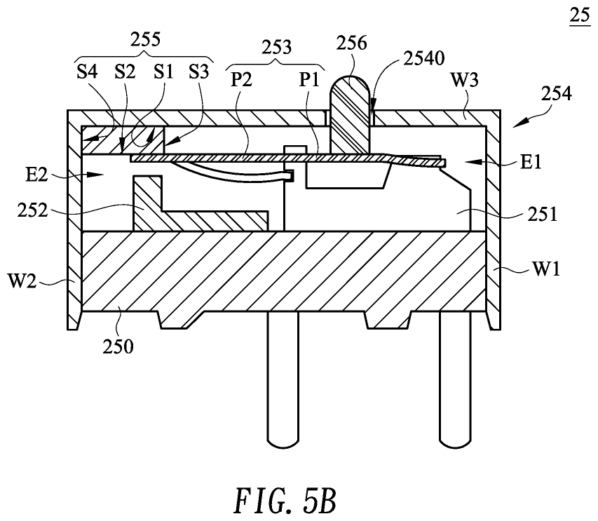

Please refer to FIGS. 3, 4, 5A and 5B. FIG. 5A is a schematic cross-sectional view illustrating the switch module as shown in FIG. 4, in which the switch module is pressed down. FIG. 5B is a schematic cross-sectional view illustrating the switch module as shown in FIG. 4, in which the external force exerted on the switch module is eliminated.

As shown in FIG. 4, the button 22 of the mouse device 2 is not pressed down and thus no external force is exerted on the resilient piece 253 of the switch module 25. Meanwhile, the pressing element 256 of the switch module 25 is not pressed by the triggering part 222 of the button 22, the resilient piece 253 is pushed by the pressing element 256, and the resilient piece 253 is not subjected to deformation. Under this circumstance, the second portion P2 of the resilient piece 253 is in an initial position. In the initial position, the second portion P2 of the resilient piece 253 is not contacted with the normally open terminal 252 and the soft element 255.

Please refer to FIG. 5A. While the button 22 of the mouse device 2 is pressed down, an external force is exerted on the resilient piece 253 of the switch module 25. Meanwhile, the pressing element 256 of the switch module 25 is pressed by the triggering part 222 of the button 22, and the first portion P1 of the resilient piece 253 is pushed by the pressing element 256. Consequently, the resilient piece 253 is subjected to deformation. At the same time, the second portion P2 of the resilient piece 253 is moved toward the switch base 250 and contacted with the normally open terminal 252. Under this circumstance, the common terminal 251 and the normally open terminal 252 are electrically connected with each other, and thus an enabling signal is generated.

Please refer to FIG. 5B. When the button 22 of the mouse device 2 is not pressed down, the external force exerted on the resilient piece 253 of the switch module 25 is eliminated. Meanwhile, the pressing element 256 of the switch module 25 is not pressed by the triggering part 222 of the button 22, and the first portion P1 of the resilient piece 253 is not pushed by the pressing element 256. In response to the elastic restoring force of the resilient piece 253, the second portion P2 of the resilient piece 253 is moved in the direction away from the switch base 250. While the second portion P2 of the resilient piece 253 is moved in the direction away from the switch base 250, the second portion P2 of the resilient piece 253 is firstly contacted with the bottom surface S2 of the soft element 255 and then the second portion P2 of the resilient piece 253 is moved to the initial position as shown in FIG. 4. That is, the second portion P2 of the resilient piece 253 is arranged between the normally open terminal 252 and the soft element 255.

In the embodiment as shown in FIG. 4, the second portion P2 of the resilient piece 253 is not contacted with the normally open terminal 252 and the soft element 255 when the second portion P2 of the resilient piece 253 is in the initial position. It is noted that the initial position of the second portion P2 of the resilient piece 253 is not restricted. For example, in another embodiment, the second portion P2 of the resilient piece 253 is contacted with the soft element 255 (see FIG. 5B) when the second portion P2 of the resilient piece 253 is in the initial position.

As mentioned above, the switch module 25 is equipped with the soft element 255 between the upper cover 254 and the second portion P2 of the resilient piece 253. While the external force exerted on the resilient piece 253 of the switch module 25 is eliminated and the second portion P2 of the resilient piece 253 is moved in the direction away from the switch base 250, the second portion P2 of the resilient piece 253 is contacted with the soft element 255. That is, the second portion P2 of the resilient piece 253 does not directly collide with the top wall W3 of the upper cover 254, and the contact between the resilient piece 253 and the soft element 255 does not generate any sound. Since the noise generated by the switch module 25 is reduced, the drawbacks of the conventional technologies are solved. In an embodiment, the soft element 255 is made of silicone or foam. The material of the soft element 255 is not restricted as long as the contact between the resilient piece 253 and the soft element 255 does not generate any sound. Moreover, the thickness of the soft element 255 (i.e., the distance between the top surface S1 and the bottom surface S2 of the soft element 255) is not restricted. The thickness of the soft element 255 is not restricted as long as the user's tactile feel corresponding to the travelling distance between the second portion P2 of the resilient piece 253 and the normally open terminal 252 is not adversely affected.

From the above descriptions, the present invention provides the switch module and the mouse device with the switch module. The switch module is equipped with the soft element between the upper cover and the resilient piece. While the external force exerted on the resilient piece is eliminated and the resilient piece is returned back, the resilient piece is contacted with the soft element. That is, the resilient piece does not directly collide with the upper cover to generate the sound. Since the noise generated by the switch module is reduced, the drawbacks of the conventional technologies are solved. This design is helpful to reduce the noise of the switch module while maintaining the tactile feel of operating the mouse device.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A switch module, comprising:
a switch base;
a common terminal disposed on a first end of the switch base;
a normally open terminal disposed on a second end of the switch base, wherein the first end and the second end are opposed to each other;
a resilient piece comprising a first portion and a second portion, wherein the first portion of the resilient piece is disposed on the common terminal, and the second portion of the resilient piece is located over the normally open terminal;
an upper cover disposed on the switch base, wherein the common terminal, the normally open terminal and the resilient piece are covered by the upper cover; and
a soft element arranged between the upper cover and the second portion of the resilient piece,
wherein when an external force is exerted on the resilient piece to press the resilient piece, the resilient piece is subjected to deformation and the second portion of the resilient piece is moved toward the switch base and contacted with the normally open terminal, so that electric connection between the common terminal and the normally open terminal is established, wherein when the external force exerted on the resilient piece is eliminated, the second portion of the resilient piece is moved in a direction away from the switch base in response to an elastic restoring force of the resilient piece, so that the second portion of the resilient piece is contacted with the soft element.

2. The switch module according to claim 1, wherein the upper cover comprises a first lateral wall, a second lateral wall and a top wall, wherein the first lateral wall and the second lateral wall are opposed to each other, the top wall is connected between the first lateral wall and the second lateral wall, the top wall of the upper cover and the switch base are opposed to each other, the first lateral wall is located near the common terminal, the second lateral wall is located near the normally open terminal, and the soft element is arranged between the top wall of the upper cover and the second portion of the resilient piece.

3. The switch module according to claim 2, wherein the soft element comprises a top surface, a bottom surface, a first lateral surface and a second lateral surface, wherein the top surface and the bottom surface are opposed to each other, the first lateral surface and the second lateral surface are connected between the top surface and the bottom surface, the top surface faces the top wall of the upper cover, the bottom surface faces the switch base, the first lateral surface faces the first lateral wall of the upper cover, the second lateral surface faces the second lateral wall of the upper cover, the top surface is in contact with the top wall of the upper cover, and the second lateral surface is in contact with the second lateral wall of the upper cover.

4. The switch module according to claim 3, wherein while the external force exerted on the resilient piece is eliminated and the second portion of the resilient piece is moved in the direction away from the switch base, the second portion of the resilient piece is contacted with the bottom surface of the soft element.

5. The switch module according to claim 2, wherein the switch module further comprises a pressing element, and the upper cover has a perforation that runs through the top wall, wherein the pressing element is in contact with the first portion of the resilient piece, and the pressing element is protruded in a direction away from the resilient piece and penetrated through the perforation of the upper cover, wherein when the first portion of the resilient piece is pushed by the pressing element in response to the external force, the resilient piece is subjected to deformation.

6. The switch module according to claim 1, wherein the soft element is made of silicone or foam.

7. A computing device, comprising:
a mouse base;
a mouse case, wherein the mouse base is covered by the mouse case;
a button installed on the mouse case, wherein an operation surface of the button is exposed outside an outer surface of the mouse case, so that the button is operable;
a circuit board disposed on the mouse base; and
a switch module arranged between the circuit board and the button, wherein the switch module comprises:
a switch base;
a common terminal disposed on a first end of the switch base;
a normally open terminal disposed on a second end of the switch base, wherein the first end and the second end are opposed to each other;
a resilient piece comprising a first portion and a second portion, wherein the first portion of the resilient piece is disposed on the common terminal, and the second portion of the resilient piece is located over the normally open terminal;
an upper cover disposed on the switch base, wherein the common terminal, the normally open terminal and the resilient piece are covered by the upper cover; and
a soft element arranged between the upper cover and the second portion of the resilient piece,
wherein when an external force is exerted on the resilient piece to press the resilient piece, the resilient piece is subjected to deformation and the second portion of the resilient piece is moved toward the switch base and contacted with the normally open terminal, so that electric connection between the common terminal and the normally open terminal is established, wherein when the external force exerted on the resilient piece is eliminated, the second portion of the resilient piece is moved in a direction away from the switch base in response to an elastic restoring force of the resilient piece, so that the second portion of the resilient piece is contacted with the soft element.

8. The mouse device according to claim 7, wherein the mouse device further comprises a scroll wheel, wherein the scroll wheel ins installed on the mouse case and partially exposed outside the mouse case, and the scroll wheel provides a window scrolling function.

9. The mouse device according to claim 7, wherein the switch module further comprises a pressing element, and the upper cover has a perforation that runs through the top wall, wherein the pressing element is in contact with the first portion of the resilient piece, and the pressing element is protruded in a direction away from the resilient piece and penetrated through the perforation of the upper cover, wherein when the first portion of the resilient piece is pushed by the pressing element in response to the external force, the resilient piece is subjected to deformation.

10. The mouse device according to claim 9, wherein the mouse case comprises an opening, and the button comprises a button body and a triggering part, wherein the button body has the operation surface, the triggering part is protruded in the direction toward the mouse base and penetrated through the opening of the mouse case so as to be contacted with the pressing element of the switch module.
